(19) United States
(12) Patent Application Publication
(10) Pub. No.: US 2016/0342979 A1
(43) Pub. Date: Nov. 24, 2016

(54) SYSTEMS AND METHODS FOR TRANSACTION AUTHENTICATION USING DYNAMIC WIRELESS BEACON DEVICES

(71) Applicant: Capital One Services, LLC, McLean, VA (US)

(72) Inventors: Anurag Joshi, Glen Allen, VA (US); William A. Hodges, Mechanicsville, VA (US); Brian E. DeLuca, Midlothian, VA (US)

(21) Appl. No.: 15/229,914

(22) Filed: Aug. 5, 2016

Related U.S. Application Data
(63) Continuation-in-part of application No. 14/680,857, filed on Apr. 7, 2015.
Application No. 14/680,857 is a continuation-in-part of application No. 14/680,842, filed on Apr. 7, 2015.
(60) Provisional application No. 62/102,857, filed on Jan. 13, 2015.
(60) Provisional application No. 61/976,703, filed on Apr. 8, 2014.
(60) Provisional application No. 61/976,703, filed on Apr. 8, 2014.
(60) Provisional application No. 62/201,775, filed on Aug. 6, 2015.

(51) Int. Cl. G06Q 20/40; H04W 76/00; H04W 4/00; H04W 12/06

(52) U.S. Cl. CPC G06Q 20/40; H04W 12/06; H04W 76/002; H04W 4/008

(57) ABSTRACT

Systems, methods, and computer-readable media are provided for authenticating transactions. An example first method includes steps performed by a server, comprising generating and storing a first identifier and sending the first identifier to a wireless beacon device associated with a transaction device over a network, receiving a transaction request comprising a proposed identifier and information related to a transaction, determining whether there is a match between the first identifier and the proposed identifier, and, based on a determination that there is a match, authorizing the transaction. An example second method includes steps performed by a user device, comprising displaying a user interface requesting information related to the transaction and receiving input comprising the information, polling, by the user device, for one or more wireless beacon devices and determining one or more identifiers associated with the wireless beacon devices, transmitting the one or more identifiers to a service provider device, and receiving information authorizing or declining the transaction.

### PRIORITY CLAIM

This application is a continuation-in-part of U.S. patent application Ser. No. 14/680,857, filed Apr. 7, 2015, which claims priority to U.S. Provisional Patent Application No. 62/102,857, filed Jan. 13, 2015, and U.S. Provisional Patent Application No. 61/976,703, filed Apr. 8, 2014. This application is also a continuation-in-part of U.S. patent application Ser. No. 14/680,842, filed Apr. 7, 2015, which claims priority to U.S. Provisional Patent Application No. 61/976,703, filed Apr. 8, 2014. This application also claims priority to U.S. Provisional Patent Application No. 62/201,775, filed Aug. 6, 2015. The disclosures of these applications are hereby incorporated by reference in their entireties.

### TECHNICAL FIELD

The disclosed embodiments generally relate to systems and methods for device interaction authentication using mobile devices and wireless beacon devices. In particular, some embodiments of the present disclosure relate to such wireless beacon devices using dynamic identifiers to securely identify mobile devices and securely authenticate transactions.

### BACKGROUND

Consumers often use mobile channels and applications when interacting with other devices. Typical mobile applications on a device (such as a smart phone or tablet) limit the number, type, or value of device interactions. For example, a user may have only three tries to authenticate with a web site before being “locked out” for submitting the wrong information. Additionally, traditional technologies may also limit the number, type, or value of transactions initiated through the use of mobile applications on a device such as a smart phone or tablet. Also, certain transactions still require physical interfaces with a machine, such as a computer terminal, ATM, or the like.

Requiring that certain transactions be conducted in person at a physical location associated with the transaction creates an inconvenience for the customer, who would prefer to initiate and authorize these transactions remotely and without having to take time to provide additional information on a machine or to a teller or to carry additional cards, tokens, “fobs,” or other account information. As another example, users frequently need to utilize computers other than those that they own (e.g., at home or at work). Securely authenticating a user so the user can use an unknown or unsecure terminal (e.g., at a coffee shop) is a risky endeavor and may require the user to carry extra devices such as brittle electronic key fobs or papers that contain one-time use passwords.

Current mechanisms for identifying a customer vary by channel (mobile, online, in person, etc.), each of which may require a set of different credentials for each distinct channel. Thus, a customer may be required to remember a username and password, social security number, account number, or pin number, depending on the channel they use to conduct financial transactions. Additionally, customers may be required to carry cards, USB devices, or other devices, with them.

Further, some typical identification systems are unable to conduct private transactions in a private location. For example, allowing a customer to initiate a transaction using a smartphone, tablet or computer from a private location (such as their own home, office, car, etc.), rather than requiring him or her to enter their information at a public device, creates a more secure authentication experience. Further, allowing a customer to conduct a transaction without swiping a card allows the customer to avoid the risk of exposing his or her information to skimmers or other fraudulent devices. Further, giving the customer the option of using the smaller screen of a smart phone or tablet allows the customer to feel secure that the smaller form factor of the smartphone or tablet allows them to keep their personal information (account number, pin, balances, types of accounts, etc.) private from other people “looking over their shoulder” when it is displayed on a screen.

Systems exist that enable users to authenticate transactions using a mobile device. For example, systems exist that cause wireless beacon devices to emit information usable to determine a location and ensure that the user of the mobile device is the same as a user that is about to utilize a transaction device. These systems provide another level of security when transferring sensitive information to other devices. But malicious users may attempt to “spoof” authentication information using duplicate beacon devices that emit the same data.

In summary, there are numerous technical problems with traditional systems and methods—including requiring customers to conduct transactions in-person (which is highly inconvenient, slow, and requires extra devices); use multiple credentials (requiring the customer to remember secure information or carry extra devices); to conduct private transactions in public places (exposing the customer to potential fraud, hacking, or snooping); or utilize insecure transaction authentication devices (exposing the customer's information to spoofing despite appearing to be secure).

The disclosed embodiments provide more security than prior art beacon devices, preventing malicious users from spoofing identifiers of the devices. For example, because customers are required to conduct less physical interaction at a transaction device (e.g., no card swipe, no pin entry, no selection of account and amount, etc.), the time the customer is at the device is greatly reduced. The disclosed embodiments also provide for higher levels of security and reduce the chance of loss of security or information.

### SUMMARY

In the following description, certain aspects and embodiments of the present disclosure will become evident. It should be understood that the disclosure, in its broadest sense, could be practiced without having one or more features of these aspects and embodiments. It should also be understood that these aspects and embodiments are merely exemplary.

Certain disclosed embodiments provide improved systems and methods for detecting, identifying, and authenticating a transaction conducted using a mobile device and a transaction device. For example, certain disclosed embodiments may enable the conducting of a broader range of transactions through mobile channels, such as a mobile application on a mobile device, without having to physically enter information on a transaction device or provide the information to an individual such as a teller. Certain disclosed embodiments may provide services that are valuable to both consumers and financial service providers. For example, aspects of the disclosed embodiments may provide a user with a process for conducting transactions from a mobile channel without the need to provide information such as a username a PIN to a machine or teller, which may save time and effort for the user and limit the exposure of customer data and personal information. Moreover, certain aspects of the disclosed embodiments may attract new customers and encourage current customers to use the service provider's accounts and services more often. The embodiments herein comprise technical solutions to these problems.

Notably, aspects of the disclosed embodiments also save computational resources by avoiding processing costs associated with electronic transactions. Instead of processing all transactions initiated by any user, authenticating a transaction before processing it will save on resources and processing time. Other computational resources can be saved, especially at a transaction device, by enabling the user to initiate the transaction even before approaching the transaction device. This unique arrangement of transaction devices and other devices (such as mobile devices) to accomplish the transaction uses fewer computational resources at the transaction device, because less time is spent using the transaction device to accomplish the transaction.

Other aspects of the disclosed embodiments are set forth below in this disclosure. For example, the disclosed embodiments may provide systems and methods for authenticating transactions performed at a transaction device. An example method may comprise steps performed by at least one processor at a server separate from the transaction device. The steps may comprise, for example, generating and storing a first identifier and sending the first identifier to a beacon device associated with a transaction device over a network. The steps may further comprise receiving, from a user device separate from the transaction device and the server, a transaction request comprising a proposed identifier and information related to a transaction. The steps may further comprise determining whether there is a match between the first identifier and the proposed identifier, and, based on a determination that there is a match, authorizing the transaction.

The disclosed embodiments also include systems and methods for authenticating a transaction performed at a user device and a transaction device. An example method may comprise steps performed by at least one processor at the user device. The steps may comprise displaying, on the user device, a user interface requesting information related to the transaction and receiving input comprising the information. The steps may further comprise polling, by the user device, for one or more beacon devices and determining one or more identifiers associated with the beacon devices, transmitting the one or more identifiers to a service provider device, and receiving information authorizing or declining the transaction.

In accordance with additional embodiments of the present disclosure, computer-readable media are disclosed that store instructions that, when executed by a processor(s), causes the processor(s) to perform operations consistent with one or more disclosed methods. Systems are also provided comprising one or more hardware devices (such as a user device, transaction device, and/or server) each of which are configured and/or programmed to perform operations consistent with one or more disclosed methods

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a block diagram of an exemplary system, consistent with disclosed embodiments.

FIG. 2 is a block diagram of an exemplary computer system, consistent with disclosed embodiments.

FIG. 3A is a flowchart of an exemplary process for updating a beacon device, consistent with disclosed embodiments.

FIG. 3B is a flowchart of an exemplary process for authorizing a transaction at a mobile device using a beacon device, consistent with disclosed embodiments.

FIG. 4 is a block diagram of an exemplary embodiment of the system in FIG. 1, consistent with disclosed embodiments.

### DETAILED DESCRIPTION

Reference will now be made in detail to exemplary embodiments, examples of which are illustrated in the accompanying drawings and disclosed herein. Wherever convenient, the same reference numbers will be used throughout the drawings to refer to the same or like parts.

Embodiments of the present disclosure are usable to authorize and secure transactions. In some embodiments, a user device (e.g., a mobile phone, smartphone, wireless device, PDA, or the like) may determine identifiers associated with one or more wireless beacons in proximity to a transaction device (such as a kiosk, a computer terminal, a point-of-sale, or an Automated Teller Machine) to the device (e.g., within some set distance such as three meters, one meter, 20 centimeters, etc.) and send the one or more identifiers to a service provider device. The service provider device may maintain a database that establishes a relationship between at least one identifier and at least one wireless beacon device. The relationship may be based on the service provider device generating and sending the identifier to the wireless beacon device over a network (or vice versa). Based on the service provider device searching the database, the service provider device may determine whether or not to authorize the transaction.

In some embodiments, the present disclosure is usable in numerous systems that employ wireless beacon devices to authenticate transactions. For example, embodiments of the present disclosure may be usable in systems such as those described in pending U.S. patent application Ser. No. 14/680,857 (filed Apr. 7, 2015), U.S. patent application Ser. No. 14/680,842 (filed Apr. 7, 2015), U.S. Provisional Application No. 62/102,857 (filed Jan. 13, 2015), or U.S. Provisional Application No. 61/976,703 (filed Apr. 8, 2014), each of which is incorporated herein by reference in their entireties.

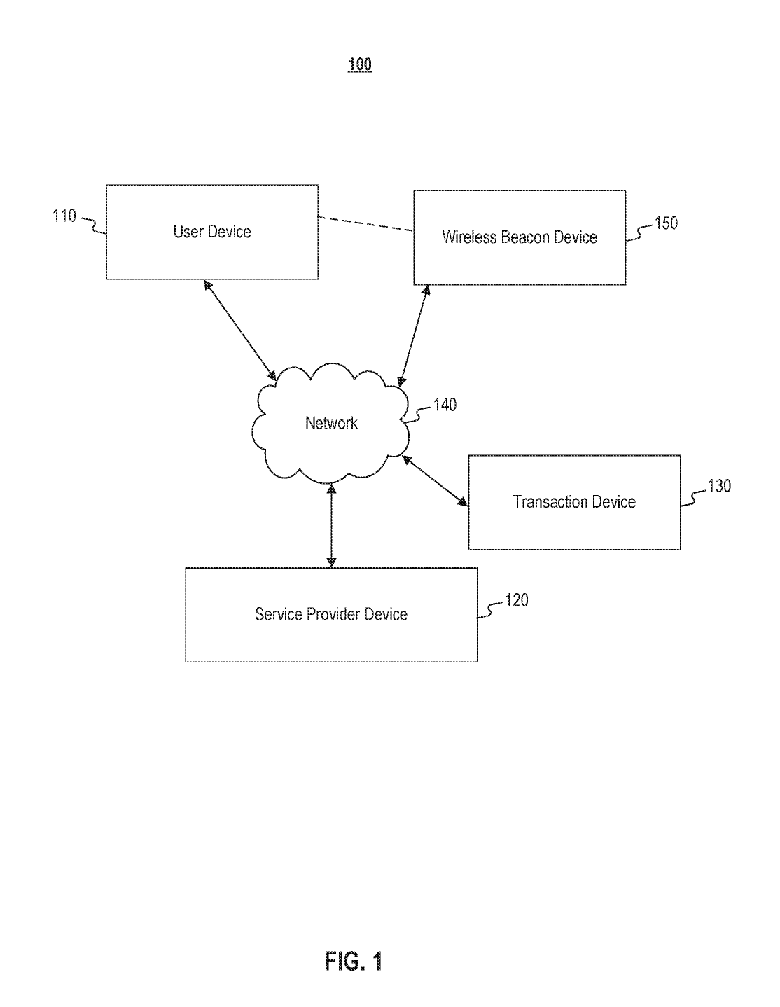

FIG. 1 shows a diagram of an exemplary system 100, consistent with disclosed embodiments. As shown in FIG. 1, system 100 may include a user device 110, a service provider device 120, a transaction device 130, a network 140 to facilitate communication among the components of system 100, and a wireless beacon device 150. The components and arrangement of the components included in system 100 may vary. Thus, system 100 may further include other components that perform or assist in the performance of one or more processes consistent with the disclosed embodiments. The components and arrangements shown in FIG. 1 are not intended to limit the disclosed embodiments, as the components used to implement the disclosed processes and features may vary.

System 100 may include one or more user devices 110. A user may operate a user device 110, which may be a desktop computer, laptop, tablet, smartphone, multifunctional watch, pair of multifunctional glasses, tracking device, or any suitable device with computing capability. User device 110 may include one or more processor(s) and memory device(s) known to those skilled in the art. For example, user device 110 may include memory device(s) that store data and software instructions that, when executed by one or more processor(s), perform operations consistent with the disclosed embodiments. In one aspect, user device 110 may have a transaction application installed thereon, which may enable user device 110 to communicate with service provider device 120, transaction device 130, or wireless beacon device 150, via network 140 or via other means (e.g., a local wireless connection such as a Bluetooth connection). For instance, user device 110 may be a smartphone or tablet or the like that executes a stored mobile application that performs various electronic transactions, such as authentication operations (e.g., logging into a computer system), banking operations (e.g., funds transfer, purchase, or cash withdrawal), or the like. In other embodiments, user device 110 may connect to service provider device 120 through use of browser software stored and executed by user device 110. User device 110 may be configured to execute software instructions to allow a user to access information stored in service provider device 120, such as, for example, financial information related to recent purchase transactions, financial discounts, financial statements, account information, rewards program information and the like. Additionally, user device 110 may be configured to execute software instructions that initiate and conduct transactions with service provider device 120 and/or transaction device 130, such as, for example, transactions such as logging into or authenticating with a website or computer, cash withdrawals, wire transfers, PIN resets, or call center transactions.

User device 110 may perform one or more operations consistent with the disclosed embodiments. User device 110 may be operated by a user. In one aspect, the user may be a customer of a financial service provider (e.g., one operating service provider device 120). For instance, a financial service provider may maintain a financial service account (e.g., checking account, savings account, debit card account, or credit card account) for the user of user device 110. User device 110 (and/or other items, such as a card, a token, a key fob, or the like) may access such an account to facilitate the purchase of goods, services, or information. Additionally or alternatively, user device 110 and the financial service account (for example, through a mobile application installed on user device 110) may initiate the withdrawal of cash from an ATM (e.g., transaction device 130), contact a customer call center, transfer or wire money, or reset their debit account PIN.

In some embodiments, user device 110 may detect wireless beacon device 150. For example, user device 110 may “poll” or “scan” to detect one or more identifiers emitted by wireless beacon device 150, using one or more wireless protocols (e.g., Near Field Communication (NFC), BLUETOOTH™, BLUETOOTH LE™ (BLE), Radio-Frequency Identification (RFID)). As explained below, wireless beacon device 150 may broadcast one or more identifiers (e.g., 128-bit identifiers) to enable user device 110 to determine the number of identity of each wireless beacon device 150, authenticate with transaction device 130 and/or service provider device 120, or the like. User device 110 may operate in a variety of modes to detect wireless beacon device 150, such as a “Near” mode (e.g., detecting all beacons within three meters of user device 110) or an “Immediate” mode (e.g., detecting only beacons within one meter of user device 110), and may alternate between these modes in order to determine which beacon devices are closest to user device 110.

In accordance with disclosed embodiments, a detection and identification system 100 may include a service provider (SP) device 120. SP device 120 may be a system associated with a website, such as a secure data storage website that stores and provides data to users. SP device 120 may also be a system associated with a financial service provider (not shown), such as a bank, a credit card company, a lender, brokerage firm, or any other type of financial service entity that generates, provides, manages, and maintains financial service accounts, etc. for one or more users.

SP device 120 may be one or more computing systems that are configured to execute software instructions stored on one or more memory devices to perform one or more operations consistent with the disclosed embodiments. For example, SP device 120 may include one or more memory device(s) storing data and software instructions, and one or more processor(s) configured to use the data and execute the software instructions to perform server-based functions and operations known to those skilled in the art. SP device 120 may include one or more general purpose computers, mainframe computers, or any combination of these types of components.

In certain embodiments, SP device 120 may be configured as a particular apparatus, system, and the like based on the storage, execution, and/or implementation of the software instructions that cause a processor to perform one or more operations consistent with the disclosed embodiments. SP device 120 may be standalone, or it may be part of a subsystem, which may be part of a larger system. For example, SP device 120 may represent distributed servers that are remotely located and communicate over a public network (e.g., network 140) or a dedicated network, such as a LAN, for a financial service provider.

SP device 120 may include or may access one or more storage devices configured to store data and/or software instructions used by one or more processors of SP device 120 to perform operations consistent with disclosed embodiments. For example, SP device 120 may include memory 230 configured to store one or more software programs that performs several functions when executed by a processor. The disclosed embodiments are not limited to separate programs or computers configured to perform dedicated tasks. For example, SP device 120 may include memory that stores a single program or multiple programs. Additionally, SP device 120 may execute one or more programs located remotely from SP device 120. For example, SP device 120 may access one or more remote programs stored in memory included with a remote component that, when executed, perform operations consistent with the disclosed embodiments. In certain aspects, SP device 120 may include server software that generates, maintains, and provides services associated with financial account management. In other aspects, SP device 120 may connect separate server(s) or similar computing devices that generate, maintain, and provide services associated with financial data for a financial service provider associated with SP device 120.

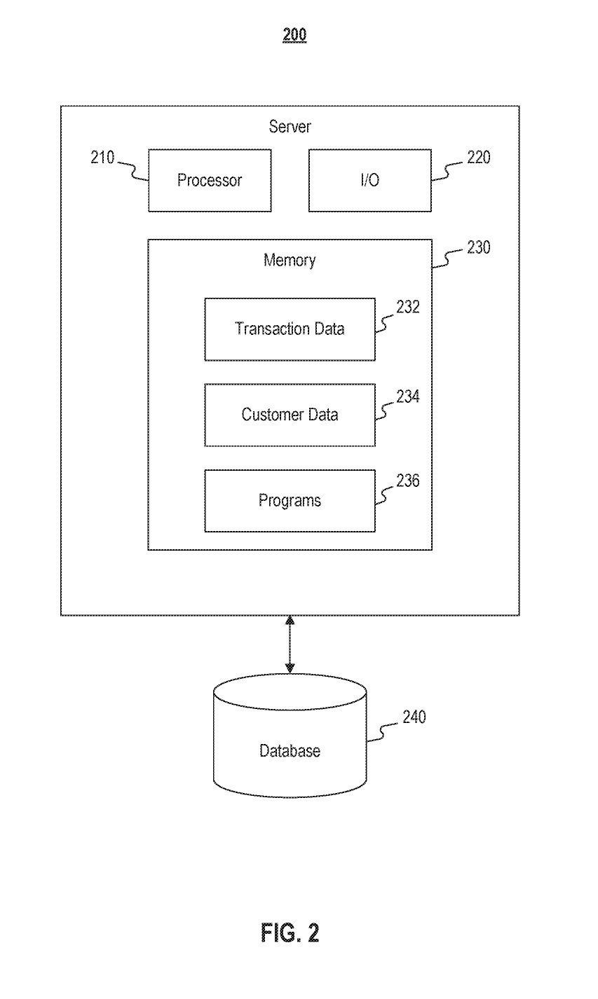

SP device 120 may be configured to generate and send one or more identifiers (e.g., 128-bit unique or semi-unique identifiers) to wireless beacon device 150. SP device 120 may also be connected to a database (such as database 240, described below with respect to FIG. 2) and may store generated identifiers and/or permanent identifiers associated with one or more wireless beacon devices 150. The database may also include other information, such as a location of wireless beacon device 150, a description or identifier associated with transaction device 120 that the wireless beacon device 150 is associated with, a physical description of wireless beacon device 150 or its location, a model number or serial number of wireless beacon device 150, or the like.

System 100 may also include one or more transaction devices 130. Transaction device 130 may be implemented as, for example, a computer terminal, a secured door, an information terminal, a kiosk, an ATM, or the like. Transaction device 130 may include one or more memory device(s) that store data that may be used for performing one or more processes consistent with the disclosed embodiments. For example, transaction device 130 may include one or more memory device(s) storing data and software instructions, and one or more processor(s) configured to use the data and execute the software instructions to perform computing functions and operations known to those skilled in the art. In certain aspects, transaction device 130 may additionally, or alternatively, include one or more servers or other types of computer devices, which may be configured to execute software instructions stored in memory to perform one or more processes consistent with the disclosed embodiments.

In certain embodiments, transaction device 130 (or a system including transaction device 130) may be configured as a particular apparatus, system, and the like based on the storage, execution, and/or implementation of the software instructions that cause a processor to perform one or more operations consistent with the disclosed embodiments. A transaction device 130 may be standalone, or it may be part of a subsystem, which may be part of a larger system. For example, transaction device 130 may represent distributed servers that are remotely located and communicate over a public network (e.g., network 140) or a dedicated network, such as a LAN. An exemplary computer system consistent with transaction device 130 is discussed in additional detail with respect to FIG. 2. In certain embodiments, a third party may operate the components associated with transaction device 130. Additionally or alternatively, transaction device 130 may be a part or subpart of SP device 120.

Network 140 may comprise any type of computer networking arrangement used to exchange data. For example, network 140 may be one or more of the Internet, a private data network, a virtual private network over a public network, a Wi-Fi network, a LAN or WAN network, and/or other suitable connections that may enable information exchange among various components of the system 100. Network 140 may also include a public switched telephone network (“PSTN”) and/or a wireless cellular network. Network 140 may be a secured network or unsecured network. In other embodiments, one or more components of system 100 may communicate directly through a dedicated communication link(s), such as links between user device 110, service provider device 120, transaction device 130, and wireless beacon device 150.

Additionally or alternatively, network 140 may include a direct communication network. Direct communications may use any suitable technologies, including, for example, BLUETOOTH™, BLUETOOTH LE™ (BLE), Wi-Fi, near field communications (NFC), or other suitable communication methods that provide a medium for transmitting data between separate devices. In certain embodiments, user device 110 and transaction device 130 may connect and communicate through a direct communications network.

Wireless beacon device 150, in some embodiments, may be implemented as a “beaconing” device that broadcasts data using a wireless protocol. Wireless beacon device 150 may broadcast data using protocols such as BLUETOOTH™, BLUETOOTH LE™ (BLE), Wi-Fi, near field communications (NFC), or the like. In some embodiments, wireless beacon device 150 comprises at least one network adapter. The at least one network adapter may comprise a wireless network adapter or a wired network adapter. Wireless beacon device 150 may be connected to network 140 using a wired connection (e.g., an Ethernet or fiber optic connection to a modem or router) via the at least one network adapter. In other embodiments, wireless beacon device 150 may additionally or alternatively be connected to network 140 using a wireless connection via the at least one network adapter. Wireless beacon device 150 may also comprise a wireless transmitter. Wireless beacon device 150 may also be configured to broadcast data using a wireless protocol (e.g., BLUETOOTH™, BLE, Wi-Fi, or NFC) via one of the at least one network adapters.

Wireless beacon device 150 may comprise one or more memory devices (e.g., flash memory) that store one or more identifiers. For example, wireless beacon device 150 may store a permanent identifier that uniquely or semi-uniquely (e.g., an identifier that is unique to all devices created by the manufacturer of wireless beacon device 150 that may not be universally unique) identifies wireless beacon device 150 as well as one or more other temporary/rolling identifiers. For example, wireless beacon device 150 may receive a temporary identifier that is valid for a period of time (e.g., 60 seconds) from SP device 120. Wireless beacon device 150 may store the temporary identifier in memory (e.g., by overwriting a previously recorded temporary identifier). At the expiration of a broadcast interval (e.g., two seconds), wireless beacon device 150 may broadcast both of a permanent identifier and a temporary identifier. In some embodiments, one or more identifiers may be stored in a database accessible to SP device 120. The database may also include other information, such as a location of wireless beacon device 150, a description or identifier associated with transaction device 120 that the wireless beacon device 150 is associated with, a physical description of wireless beacon device 150 or its location, a model number or serial number of wireless beacon device 150, or the like.

Other components known to one of ordinary skill in the art may be included in system 100 to process, transmit, provide, and receive information consistent with the disclosed embodiments.

FIG. 2 shows a diagram of an exemplary computing system 200 illustrating a computing system configuration that may be associated with user device 110, service provider device 120, or transaction device 130, consistent with disclosed embodiments. In some embodiments, computing system 200 may include one or more processors 210, one or more memories 230, and one or more input/output (I/O) devices 220. In some embodiments, computing system 200 may take the form of a server, general purpose computer, a mainframe computer, laptop, smartphone, mobile device, or any combination of these components. In certain embodiments, computing system 200 (or a system including computing system 200) may be configured as a particular apparatus, system, and the like based on the storage, execution, and/or implementation of the software instructions that cause a processor to perform one or more operations consistent with the disclosed embodiments. Computing system 200 may be standalone, or it may be part of a subsystem, which may be part of a larger system.

Processor 210 may include one or more known processing devices, such as a microprocessor from the Pentium™ or Xeon™ family manufactured by Intel™, the Turion™ family manufactured by AMD™, or any of various processors manufactured by Sun Microsystems. Processor 210 may constitute a single core or multiple core processor that executes parallel processes simultaneously. For example, processor 210 may be a single core processor configured with virtual processing technologies. In certain embodiments, processor 210 may use logical processors to simultaneously execute and control multiple processes. Processor 210 may implement virtual machine technologies, or other known technologies to provide the ability to execute, control, run, manipulate, store, etc. multiple software processes, applications, programs, etc. In another embodiment, processor 210 may include a multiple-core processor arrangement (e.g., dual, quad core, etc.) configured to provide parallel processing functionalities to allow computing system 200 to execute multiple processes simultaneously. One of ordinary skill in the art would understand that other types of processor arrangements could be implemented that provide for the capabilities disclosed herein. The disclosed embodiments are not limited to any type of processor(s) configured in computing system 200.

Memory 230 may include one or more storage devices configured to store instructions used by processor 210 to perform functions related to the disclosed embodiments. For example, memory 230 may be configured with one or more software instructions, such as program(s) 236 that may perform one or more operations when executed by processor 210. The disclosed embodiments are not limited to separate programs or computers configured to perform dedicated tasks. For example, memory 230 may include a program 236 that performs the functions of computing system 200, or program 236 could comprise multiple programs. Additionally, processor 210 may execute one or more programs located remotely from computing system 200. For example, user device 110, service provider device 120, or transaction device 130 may, via computing system 200 (or variants thereof), access one or more remote programs that, when executed, perform functions related to certain disclosed embodiments. Processor 210 may further execute one or more programs located in database 240. In some embodiments, programs 236 may be stored in an external storage device, such as a cloud server located outside of computing system 200, and processor 210 may execute programs 236 remotely.

Programs executed by processor 210 may cause processor 210 to execute one or more processes related to financial services provided to users including, but not limited to, logging into or authenticating with a website or computer, processing credit and debit card transactions, checking transactions, fund deposits and withdrawals, transferring money between financial accounts, lending loans, processing payments for credit card and loan accounts, processing orders for certified funds, processing orders for new or reissue debit cards, and processing ATM cash withdrawals.

Memory 230 may also store data that may reflect any type of information in any format that the system may use to perform operations consistent with the disclosed embodiments. Memory 230 may store instructions to enable processor 210 to execute one or more applications, such as server applications, an authentication application, network communication processes, and any other type of application or software. Alternatively, the instructions, application programs, etc., may be stored in an external storage (not shown) in communication with computing system 200 via network 140 or any other suitable network. Memory 230 may be a volatile or non-volatile, magnetic, semiconductor, tape, optical, removable, non-removable, or other type of storage device or tangible (i.e., non-transitory) computer-readable medium.

Memory 230 may include transaction data 232. Transaction data 232 may include information related to financial transactions initiated by a user. For example, transaction data may include a user identifier and a transaction type. The user identifier may be a username, a password, a unique identifier of user device 110, a credit or debit card number, an account number, or other data useful in identifying the user initiating the transaction. The transaction type may include an indicator of the type of transaction the user is initiating. Additionally or alternatively, transaction data 232 may be stored in database 240 or in an external storage (not shown) in communication with computing system 200 via network 140 or any other suitable network.

Memory 230 may further include customer data 234. Customer data 234 may include information about particular customers of the service provider. Customer data 234 may also include user device identification information, such as, for example, a phone number, email address, IP address, BLUETOOTH™ signature, or other device identifier. In embodiments where SP device 120 is operated by a financial service provider such as a bank or credit unit, customer data 234 may include clients' account information, debit or credit card information, history of purchase transactions, financial statements, credit score, risk profile, username and password, debit card PIN, home and work locations, authentication data, or the like. Alternatively customer data 234 may be stored in database 240 or in an external storage (not shown) in communication with computing system 200 via network 140 or any other suitable network.

Processor 210 may analyze transaction data 232 in reference to customer data 234. For example, processor 210 may analyze transaction data to determine which client with information stored in client information 234 is initiating the financial transaction. Processor 210 may access the particular user's customer information to determine their account information, debit or credit card information, history of purchase transactions, financial statements, credit score, risk profile, username and password, debit card PIN, home and work locations, authentication data, or the like.

I/O devices 220 may be one or more device that is configured to allow data to be received and/or transmitted by computing system 200. I/O devices 220 may include one or more digital and/or analog communication devices that allow computing system 200 to communicate with other machines and devices, such as other components of system 100 shown in FIG. 1. For example, computing system 200 may include interface components, which may provide interfaces to one or more input devices, such as one or more keyboards, mouse devices, and the like, which may enable computing system 200 to receive input from an operator of SP device 120 (not shown).

Computing system 200 may also contain one or more database(s) 240. Alternatively, computing system 200 may be communicatively connected to one or more database(s) 240. Computing system 200 may be communicatively connected to database(s) 240 through network 140. Database 240 may include one or more memory devices that store information and are accessed and/or managed through computing system 200. By way of example, database(s) 240 may include Oracle™ databases, Sybase™ databases, or other relational databases or non-relational databases, such as Hadoop sequence files, HBase, or Cassandra. The databases or other files may include, for example, data and information related to the source and destination of a network request and the data contained in the request, etc. Systems and methods of disclosed embodiments, however, are not limited to separate databases. Database 240 may include computing components (e.g., database management system, database server, etc.) configured to receive and process requests for data stored in memory devices of database(s) 240 and to provide data from database 240. Database 240 may also include other information, such as a location of wireless beacon device 150, a description or identifier associated with transaction device 120 that the wireless beacon device 150 is associated with, a physical description of wireless beacon device 150 or its location, a model number or serial number of wireless beacon device 150, or the like. (In some embodiments, this data may additionally or alternatively be stored in memory 230.)

As discussed above, SP device 120 may include at least one computing system 200. Further, although sometimes discussed here in relation to SP device 120, it should be understood that variations of computing system 200 may be used by other components of system 100, including transaction device 130 and user device 110. Computing system 200 may be a single server or may be configured as a distributed computer system including multiple servers or computers that interoperate to perform one or more of the processes and functionalities associated with the disclosed embodiments.

In some aspects, transaction device 130 and/or user device 110 may include the same or similar configuration and/or components of computing system 200. For example, computing system 200, when implemented in transaction device 130, may include hardware and/or software installed therein for performing one or more processes disclosed herein.

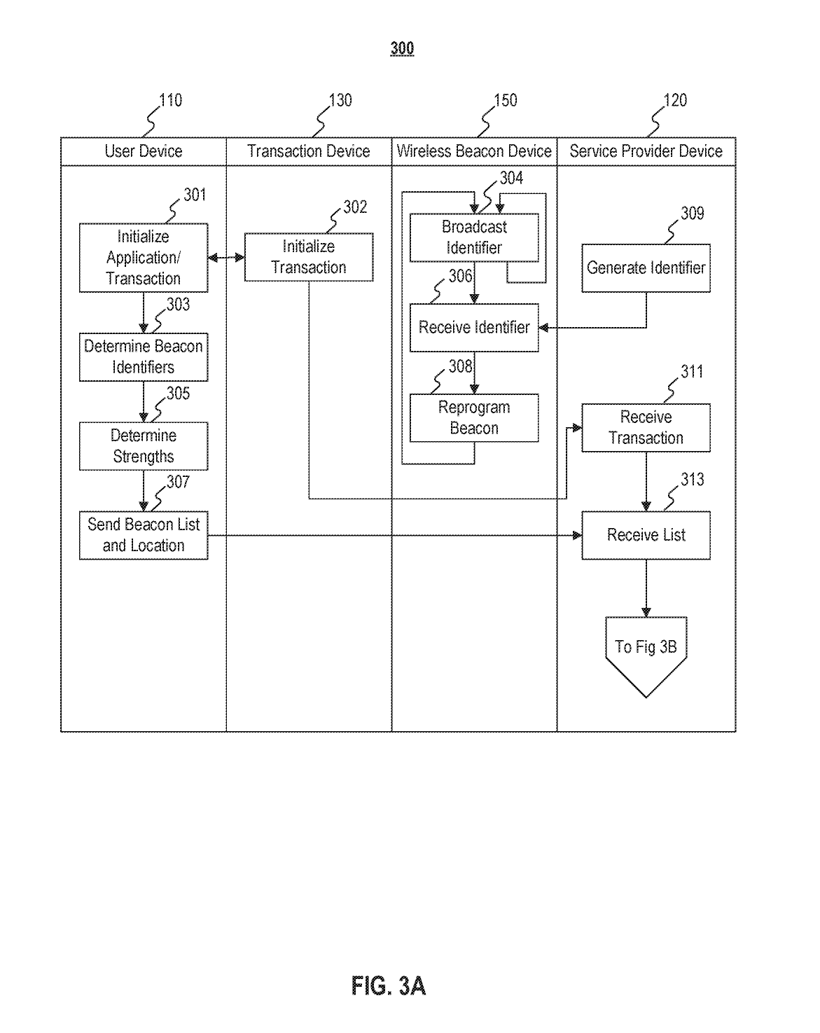

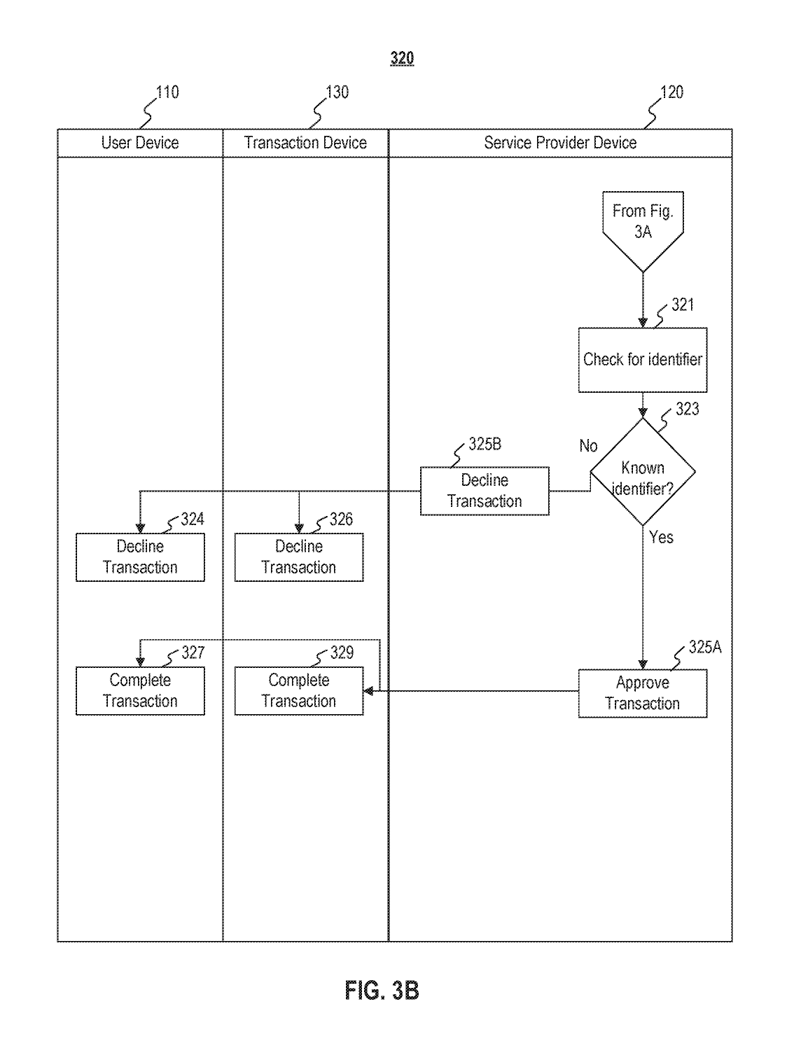

FIG. 3A is a flowchart of an exemplary process 300 for updating a beacon device, consistent with disclosed embodiments.

Process 300 begins with steps 301 or 302. In step 301, a user (e.g., a consumer, client, authorized user, cardholder, etc.) may utilize user device 110 to initialize an application and/or a transaction. For example, user device 110 may receive a user click on an icon on a display of user device 110 in order to initialize an application for authenticating a transaction such as a log-in process, a purchase, or an ATM withdrawal, and send a transaction request to service provider device 120.

Additionally or alternatively, transaction device 130 may initialize the transaction. For example, if transaction device 130 is a computer terminal, initializing the transaction may comprise the user attempting to log in or otherwise authenticating to use transaction device 130. As another example, if transaction device 130 is an ATM, initializing the transaction may comprise the user inserting a card and entering a PIN or other password on transaction device 130. After initializing the transaction in step 302, transaction device 130 may send one or more details about the transaction (e.g., a possible identity of the user or user device 110 or a transaction request) to service provider device 120, which receives it in step 311.

In some embodiments, if the transaction is initialized in step 302 at transaction device 130, user device 110 may initialize an application (as in step 301) in response to a signal from transaction device 130, service provider device 120, or another device.

Along with steps 301 and 302, steps 304 and 309 may, in some embodiments, operate continuously and independently of steps 301 and 302. In step 304, wireless beacon device 150 broadcasts one or more identifiers over a wireless channel. The identifiers may comprise one or more of a permanent identifier (uniquely or semi-uniquely identifying wireless beacon device 150) or a temporary identifier (e.g., one that is generated by or received from service provider device 120).

In step 309, service provider device 120 may generate a new identifier for use by wireless beacon device 150. In some embodiments, service provider device 120 may generate a number or series of numbers (e.g., 128 bits) as a temporary identifier for wireless beacon device 150. SP device 120 may generate the identifier using, for example, a pseudo-random number generator and may send the identifier to wireless beacon device 150.

In other embodiments, wireless beacon device 150 may generate an identifier without receiving one from SP device 120. For example, both SP device 120 and wireless beacon device 150 may utilize the same pseudo-random number generator having the same seed value, then both devices can generate the same identifier at the same time, thus obviating any need for a connection between the devices.

In step 306, wireless beacon device 150 may receive a generated identifier from SP device 120. In step 308, wireless beacon device 150 may reprogram a broadcast function on wireless beacon device 150 to broadcast the received identifier. For example, wireless beacon device 150 may overwrite a location in memory storing the current identifier using the identifier received in step 306.

In step 303, user device 110 may determine beacon identifiers associated with one or more wireless beacon device(s) 150. For example, user device 110 may listen on known frequencies in order to determine one or more identifiers being broadcast by wireless beacon device 150.

In step 305, user device 110 may determine the relative strengths of each determined signal containing an identifier. For example, user device 110 may record the strength of each distinct signal that contains a different identifier. Signal strength (which may be measured in in dBm or Decibel-milliwatts) may indicate the relative distances between particular wireless beacon devices 150 and user device 110. For example, if a first identifier is received with a first signal at −25 dBm and a second identifier is received with a second signal at −55 dBm, user device 110 may record that a first wireless beacon device (emitting at −25 dBm) is likely closer to user device 110 than a second wireless beacon device.

User device 110 may operate in multiple modes of operation in order to determine which beacon devices are close to user device 110 and which are not. For example, if multiple wireless beacon devices 150 are implemented using BLE (Bluetooth Low Energy), user device 110 may initially operate in “Near” mode (e.g., detecting all beacons within three meters of user device 110) and may switch to “Immediate” mode (e.g., detecting only beacons within one meter of user device 110). User device 110 may then determine the wireless beacon device closest to user device 110 based on the identifiers received in each mode.

In step 307, user device 110 may generate a list of detected beacon devices. In some embodiments, the list may be ordered by determined signal strengths or by some other order (e.g., whether the beacon device was detected in Near mode vs. Immediate mode). In other embodiments, the list of detected beacon devices may comprise only a single beacon device, such as the beacon device 150 that user device 110 determines is closest. User device 110 may also send a location associated with user device 110 to SP device 120. For example, user device 110 may utilize a GPS device to determine a current location of user device 110 and may send it to SP device 120. This list (and any associated location information) may be received by SP device 120 in step 313.

FIG. 3B is a flowchart of an exemplary process 320 for authorizing a transaction at a mobile device using a beacon device, consistent with disclosed embodiments. Process 320 begins at step 321. In step 321, SP device 120 may determine whether one or more of the beacons on the list received in step 313 is included in a database (e.g., database 240 in FIG. 2). This determination may include comparing temporary and/or permanent identifiers on the list with identifiers in database 240 and may include comparing location information received in step 313 with location information related to the beacons whose identifiers were received in step 313 (e.g., location of the beacons associated with received identifiers). If SP device 120 determines at step 323 that there is a match (e.g., a received identifier is in database 240 and received location information matches location information stored in association with the identifier in database 240), process 320 may continue to step 325A where SP device 120 may generate and send information approving the transaction to user device 110 and/or transaction device 130. If there is no such match (step 323; No), process 320 may continue to step 325B where SP device 120 may generate and send information declining the transaction to user device 110 and/or transaction device 130.

When user device 110 and/or transaction device 130 receives information declining the transaction in steps 324 or 326, respectively, these devices may take steps to prevent the transaction from completing. For example, in step 324, user device 110 may instruct the user to get closer to a particular transaction device 130, may instruct the user to retry the transaction, or may initiate fraud sequences such as disabling user device 110 (e.g., in case the identifier received in step 313 is known to be a fraudulent identifier or user device 110 has been stolen). In step 326, transaction device 130 may similarly instruct the user to retry the transaction or may initiate fraud sequences such as disabling transaction device 130.

When user device 110 and/or transaction device 130 receives information approving the transaction in steps 327 or 329, respectively, these devices may take steps to finish the transaction. For example, if the user utilized user device 110 to initiate a log-in procedure by entering a username or password on user device 110, user device 110 may display a one-time use password and transaction device 130 may prompt the user to enter the one-time use password in order to finish the log-in procedure. As another example, if the user utilized user device 110 to initiate a cash withdrawal procedure having a particular amount of money, transaction device 130 may prompt the user to merely insert an ATM card, after which transaction device 130 will deliver the requested amount of money to the user.

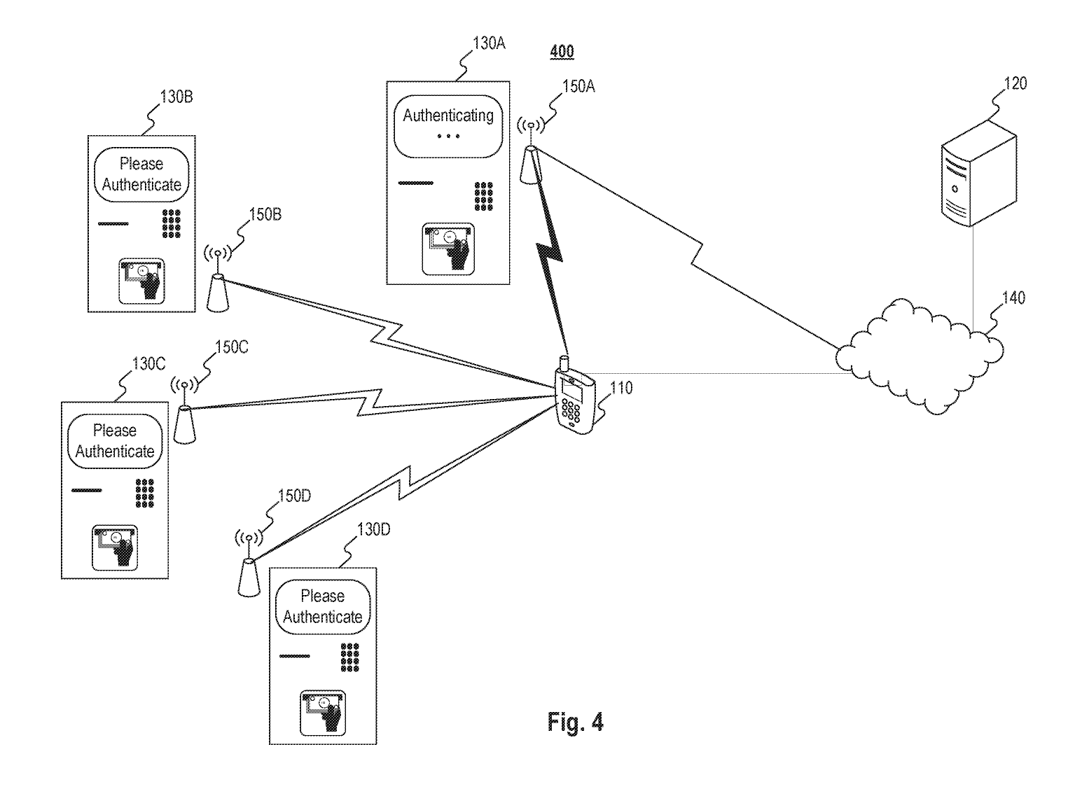

FIG. 4 is a block diagram of an exemplary embodiment 400 of the system in FIG. 1, consistent with disclosed embodiments. Embodiment 400 includes user device 110, SP device 120, network 140, and transaction devices 130A-130D and respective wireless beacon devices 150A-150D. In embodiment 400, each transaction device is associated with a respective wireless beacon device. In some embodiments, each transaction device is located a short distance from each wireless beacon device, but is not directly connected to the respective wireless beacon device. Wireless beacon devices 150A-150D may be connected to network 140 using a wired connection (not shown) such as dedicated or non-dedicated link (e.g., a cable modem, DSL line, T-1 connection, fiber-optic connection, or an Ethernet connection to a router).

In embodiment 400, user device 110 is closest to wireless beacon device 150A. As explained above with respect to FIGS. 3A and 3B, service provider device 120 may authorize the transaction at the transaction device associated with the wireless beacon device closest to user device 110, which in embodiment 400 is transaction device 130A. In some embodiments, a wireless beacon device may be “associated” with a particular transaction device in that it is the closest wireless beacon device to the transaction device, identified as being the wireless beacon device for the transaction device, or otherwise assigned to the transaction device. The user may insert a card or enter a username on transaction device 130A in order to complete the transaction.

In certain embodiments, such as those where the user has requested cash from an ATM, dispensing the requested denominations of bills may complete the transaction. Prior to or following dispensing, transaction device 130A may display to the user a message indicating that the transaction is processing. For example, transaction device 130A may contain a screen or other display. In certain embodiments, messages, such as those reflecting the results of authentication operations may be displayed to the user via the screen or display of transaction device 130A. Similarly, following dispensing the requested bills, transaction device 130A may display to the user a message indicating that the transaction is complete. Moreover, transaction devices 130B-130D may not display any messages to the user because they are not performing any procedures for the user.

In some examples, some or all of the logic for the above-described techniques may be implemented as a computer program or application or as a plugin module or sub component of another application. The described techniques may be varied and are not limited to the examples or descriptions provided. In some examples, applications may be developed for download to mobile communications and computing devices, e.g., laptops, mobile computers, tablet computers, smart phones, etc., being made available for download by the user either directly from the device or through a website.

Moreover, while illustrative embodiments have been described herein, the scope thereof includes any and all embodiments having equivalent elements, modifications, omissions, combinations (e.g., of aspects across various embodiments), adaptations and/or alterations as would be appreciated by those of skill in the art based on the present disclosure. For example, the number and orientation of components shown in the exemplary systems may be modified. Further, with respect to the exemplary methods illustrated in the attached drawings, the order and sequence of steps may be modified, and steps may be added or deleted.

Thus, the foregoing description has been presented for purposes of illustration. It is not exhaustive and is not limiting to the precise forms or embodiments disclosed. Modifications and adaptations will be apparent to those skilled in the art from consideration of the specification and practice of the disclosed embodiments. For example, while a financial service provider has been described herein as the entity detecting and identifying customers, it is to be understood that consistent with disclosed embodiments another entity may provide such services in conjunction with or separate from a financial service provider.

The claims are to be interpreted broadly based on the language employed in the claims and not limited to examples described in the present specification, which examples are to be construed as non-exclusive. Further, the steps of the disclosed methods may be modified in any manner, including by reordering steps and/or inserting or deleting steps.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead are defined by the appended claims in light of their full scope of equivalents.

What is claimed is:

1. A system, comprising:
a service provider device, comprising:
a processor; and
memory storing instructions configured to cause the processor in the service provider device to perform a method comprising:
generating and storing a first identifier;
sending, over a network, the first identifier to a wireless beacon device associated with a transaction device, the beacon device configured to broadcast a wireless signal correlated to the first identifier;
receiving, from a user device or the transaction device over the network, a transaction request comprising a proposed identifier and information related to a transaction;
determining whether there is a match between the first identifier and the proposed identifier; and
based on determining that there is a match between the first identifier and the proposed identifier, authorizing the transaction request; and
a wireless beacon device, comprising:
a network adapter;
a processor; and
memory storing a permanent identifier, a temporary identifier, and instructions, the instructions configured to cause the processor in the wireless beacon device to perform a method comprising:
receiving, using the network adapter, an identifier;
overwriting the temporary identifier in memory using the received identifier; and
wirelessly broadcasting the temporary identifier and the permanent identifier stored in the memory,
wherein the steps of receiving and broadcasting are performed using two different network adapters.

2. The system of claim 1, wherein authorizing the transaction request comprises transmitting information over the network to at least one of the user device or the transaction device.

3. The system of claim 1, wherein the processor in the service provider device is further configured to perform steps comprising:
generating and storing a second identifier for the wireless beacon device; and
sending the second identifier to the wireless beacon device for overwriting the first identifier.

4. The system of claim 1, wherein the wireless beacon device is located closer to the transaction device than at least one second wireless beacon device.

5. A method for authenticating a transaction performed at a transaction device, the method comprising steps performed by at least one processor at a server, the method comprising:
generating and storing a first identifier;
sending, over a network, the first identifier to a wireless beacon device associated with a transaction device, the wireless beacon device configured to broadcast a wireless signal correlated to the first identifier;
receiving, from a user device or the transaction device over the network, a transaction request comprising a proposed identifier and information related to a transaction;
determining whether there is a match between the first identifier and the proposed identifier; and
based on determining that there is a match between the first identifier and the proposed identifier, authorizing the transaction request.

6. The method of claim 5, wherein authorizing the transaction request comprises transmitting information over the network to at least one of the user device or the transaction device.

7. The method of claim 5, further comprising:
generating and storing a second identifier for the beacon device; and
sending the second identifier to the beacon device for overwriting the first identifier.

8. The method of claim 5, wherein the wireless beacon device is located closer to the transaction device than at least one second wireless beacon device.

9. A method for authenticating a transaction performed at a user device and a transaction device, the method comprising steps performed by at least one processor at the user device, the method comprising
displaying a user interface on the user device requesting information related to the transaction;
receiving input comprising the information related to the transaction;
polling for one or more beacon devices in proximity to the user device;
determining one or more identifiers emitted by the wireless beacon devices;
transmitting the one or more identifiers to a service provider device; and
receiving information authorizing or declining the transaction.

10. The method of claim 9, wherein transmitting the one or more identifiers further comprises sending the one or more identifiers and location data associated with the user device.

11. The method of claim 9, wherein the polling operates using a wireless short-range protocol.

12. The method of claim 11, further comprising determining a closest wireless beacon device by:
polling using a first polling mode to detect a first set of wireless beacon devices within a first range of the user device;
polling using a second polling mode to detect a second set of wireless beacon devices within a second range of the user device, the second range being smaller than the first range; and
selecting a wireless beacon device from the second set of wireless beacon devices based on the signal strength,
wherein transmitting the one or more identifiers to a service provider device comprises transmitting an identifier associated with the selected wireless beacon device.

13. A user device, comprising:
a display;
a processor; and
memory storing instructions configured to cause the processor to perform a method comprising:
displaying a user interface on the display requesting information related to the transaction;
receiving input comprising the information related to the transaction;
polling for one or more wireless beacon devices in proximity to the user device;
determining one or more identifiers associated with the wireless beacon devices;
transmitting the one or more identifiers to a service provider device; and
receiving information authorizing or declining the transaction.

14. The user device of claim 13, wherein transmitting the one or more identifiers further comprises sending the one or more identifiers and location data associated with the user device.

15. The user device of claim 13, wherein the polling operates using a wireless short-range protocol.

16. The user device of claim 15, further comprising determining a closest wireless beacon device by:
polling using a first polling mode to detect a first set of wireless beacon devices within a first range of the user device;
polling using a second polling mode to detect a second set of wireless beacon devices within a second range of the user device, the second range being smaller than the first range; and
selecting a wireless beacon device from the second set of wireless beacon devices based on the signal strength, and
wherein transmitting the one or more identifiers to a service provider device comprises transmitting an identifier associated with the selected wireless beacon device.
